(19) United States
(12) Patent Application Publication
(10) Pub. No.: US 2025/0304464 A1
(43) Pub. Date: Oct. 2, 2025

(54) CATHODE ACTIVE MATERIAL FOR LITHIUM ION SECONDARY BATTERY, LITHIUM ION SECONDARY BATTERY AND METHOD FOR MANUFACTURING CATHODE ACTIVE MATERIAL FOR LITHIUM ION SECONDARY BATTERY

(71) Applicant: HONDA MOTOR CO., LTD., Tokyo (JP)

(72) Inventors: Kazuki CHIBA, Saitama (JP); Kazumasa SAKATSUME, Saitama (JP); Takashi HAKARI, Saitama (JP); Akihisa TANAKA, Saitama (JP); Yoshiyuki MORITA, Saitama (JP)

(21) Appl. No.: 19/051,556

(22) Filed: Feb. 12, 2025

(30) Foreign Application Priority Data
Mar. 26, 2024 (JP) 2024-048918

(51) Int. Cl. C01G 53/504; H01M 10/0525

(52) U.S. Cl. CPC C01G 53/504; H01M 10/0525; C01P 2002/72; C01P 2006/40

(57) ABSTRACT

There is provided a cathode active material for a lithium ion secondary battery containing a lithium transition metal composite oxide as a main component, wherein
the lithium transition metal composite oxide is in a form of a particle having an outer layer on a surface of the particle,
the lithium transition metal composite oxide is represented by the following Formula (1):

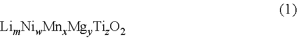

wherein m, w, x, y, and z are respectively in ranges of 1.00≤m≤1.04, 0.47<w<0.59, 0.40≤x<0.50, 0<y≤0.04, and 0≤z<0.04, and x≤w, and m+w+x+y+z=2, and
a ratio of the number of Mn atoms to the number of Ni atoms (Mn/Ni ratio) in the outer layer is 1.0 or more and 1.5 or less.

### BACKGROUND

### Technical Field

The present invention relates to a cathode active material for a lithium ion secondary battery, a lithium ion secondary battery, and a method for manufacturing a cathode active material for a lithium ion secondary battery.

### Related Art

In recent years, research and development on secondary batteries that contribute to improvement of energy efficiency have been conducted. In particular, lithium ion secondary batteries are becoming increasingly important as power sources for electric vehicles (EV), hybrid electric vehicles (HEV), and the like.

A cathode active material has attracted attention as an important component for determining the capacity of a lithium ion secondary battery, and development thereof has been advanced. As a cathode active material used for a lithium ion secondary battery, for example, a composite oxide in which nickel and manganese in a lithium-nickel-manganese composite oxide are partially replaced with titanium or magnesium has been reported (for example, S.-H. Kang, et al., “Comparative study of Li(Ni_{0.5-x}Mn_{0.5-x}M₂ₓ′)O₂(M′=Mg, Al, Co, Ni, Ti; x=0, 0. 025) cathode materials for rechargeable lithium batteries” Journal of Power Sources. 119-121, 150-155 (2003)).

### CITATION LIST

### Non Patent Literature

Non Patent Literature 1: S.-H. Kang, et al., “Comparative study of Li(Ni_{0.5-x}Mn_{0.5-x}M_{2x′})O₂ (M′=Mg, Al, Co, Ni, Ti; x=0,0.025) cathode materials for rechargeable lithium batteries” Journal of Power Sources. 119-121, 150-155 (2003)

### SUMMARY

In S.-H. Kang, et al., “Comparative study of Li(Ni_{0.5-x}Mn_{0.5-x}M_{2x′})O₂ (M′=Mg, Al, Co, Ni, Ti; x=0,0.025) cathode materials for rechargeable lithium batteries” Journal of Power Sources. 119-121, 150-155 (2003), the discharge capacity at 4.3 to 2.8 V is about 130 mAhg⁻¹, and there is room for improvement. In addition, the lithium ion secondary battery is required not to decrease the capacity (increase the capacity retention rate) even when charging and discharging are repeated.

The present invention has been made to solve the problems as described above, and an object thereof is to provide a cathode active material for a lithium ion secondary battery with which a lithium ion secondary battery having higher discharge capacity and capacity retention rate can be obtained, a lithium ion secondary battery using the cathode active material, and a method for manufacturing the cathode active material for a lithium ion secondary battery. The present invention consequently contributes to energy efficiency.

In order to achieve the above-described object, the present invention provides the following.
[1] A cathode active material for a lithium ion secondary battery containing a lithium transition metal composite oxide as a main component, wherein
the lithium transition metal composite oxide is in a form of a particle having an outer layer on a surface of the particle,
the lithium transition metal composite oxide is represented by the following Formula (1):

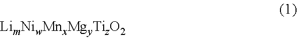

wherein m, w, x, y, and z are respectively in ranges of 1.00≤m≤1.04, 0.47<w<0.59, 0.40≤x<0.50, 0<y≤0.04, and 0≤z<0.04, and x≤w, and m+w+x+y+z=2, and
a ratio of a number of Mn atoms to a number of Ni atoms (Mn/Ni ratio) in the outer layer is 1.0 or more and 1.5 or less.

The cathode active material for a lithium ion secondary battery (hereinafter, also simply referred to as a “cathode active material”) according to [1] contains magnesium (Mg) having an atomic mass smaller than that of nickel (Ni) or manganese (Mn). Therefore, even if the content of Ni is reduced, the decrease in the discharge capacity can be reduced or made equivalent. In addition, in the cathode active material according to [1], the Mn/Ni ratio in the outer layer satisfies a specific numerical range. Therefore, the capacity retention rate of a lithium ion secondary battery (hereinafter, also simply referred to as a “secondary battery”) using the cathode active material can be further increased. Accordingly, in the secondary battery, it is possible to reduce the number of batteries required and contribute to extending the life of the battery. That is, it is possible to contribute to improvement of energy efficiency.
[2] The cathode active material for a lithium ion secondary battery according to [1], wherein a ratio of a number of Mg atoms to the number of Ni atoms (Mg/Ni ratio) in the outer layer is 0.02 or more and 0.15 or less, and a ratio of the ratio of the number of Mg atoms to the number of Ni atoms (Mg/Ni ratio) in the outer layer to the ratio of the number of Mg atoms to the number of Ni atoms (Mg/Ni ratio) in the entire particle (chemical composition of the particle) is 1.0 or more and 5.0 or less.

In the cathode active material according to [2], the Mg/Ni ratio in the outer layer and the ratio of the Mg/Ni ratio in the outer layer to the Mg/Ni ratio in the entire particle satisfy specific numerical ranges. Therefore, release of oxygen from the cathode active material at the time of initial charge can be suppressed, and the discharge capacity can be further increased. In addition, the capacity retention rate can be further increased. Therefore, it is possible to contribute to further improvement of energy efficiency.
[3] The cathode active material for a lithium ion secondary battery according to [1] or [2], wherein Ti is contained, a ratio of a number of Ti atoms to the number of Ni atoms (Ti/Ni ratio) in the outer layer is 0.02 or more and 0.25 or less, and a ratio of the ratio of the number of Ti atoms to the number of Ni atoms (Ti/Ni ratio) in the outer layer to the ratio of the number of Ti atoms to the number of Ni atoms (Ti/Ni ratio) in the entire particle (chemical composition of the particle) is 1.0 or more and 20.0 or less.

The cathode active material according to [3] contains titanium (Ti) having an atomic mass smaller than that of Ni or Mn. Therefore, even if the content of Ni is reduced, the decrease in the discharge capacity can be reduced or made equivalent, and the capacity retention rate can be further increased. Accordingly, it is possible to contribute to further improvement of energy efficiency.
[4] The cathode active material for a lithium ion secondary battery according to any one of [1] to [3], wherein in an X-ray diffraction pattern obtained using a Cu radiation source, diffraction peaks of a 108 plane and a 110 plane in a space group R-3m are split, and a full width at half maximum of the diffraction peak of the 110 plane is 0.10° or more and 0.21° or less.

In the cathode active material for a lithium ion secondary battery according to [4], the diffraction peaks of the 108 plane and the 110 plane are split, and the full width at half maximum of the diffraction peak of the 110 plane is 0.10° or more and 0.21° or less. This indicates that Ni, Mn, and Mg, or Ni, Mn, Mg, and Ti are uniformly dispersed without undergoing phase separation. That is, it indicates that in the lithium transition metal composite oxide, Ni, Mn, and Mg, or Ni, Mn, Mg, and Ti do not undergo phase separation but are included therein in a form of solid solution therewith. Therefore, it is possible to contribute to further improvement of energy efficiency.
[5] The cathode active material for a lithium ion secondary battery according to any one of [1] to [4], wherein among lattice constants of the lithium transition metal composite oxide in a space group R-3m, an a-axis length is 2.881 Å to 2.893 Å, a c-axis length is 14.28 Å to 14.31 Å, and c/a is 4.948 to 4.958.

In the cathode active material according to [5], the lattice constants satisfy specific numerical ranges. Therefore, in the lithium transition metal composite oxide, lithium ions are easily diffused in the particles, and the resistance is low. Accordingly, it is possible to contribute to further improvement of energy efficiency.
[6] A lithium ion secondary battery including: a cathode; an anode; and an electrolyte, wherein the cathode contains the cathode active material for a lithium ion secondary battery according to any one of [1] to [5].

In the lithium ion secondary battery according to [6], the cathode contains the cathode active material for a lithium ion secondary battery. Therefore, the discharge capacity and the capacity retention rate can be further increased, the number of batteries required can be reduced, which can contribute to extending the life of the battery. That is, it is possible to contribute to improvement of energy efficiency.
[7] A method for manufacturing the cathode active material for a lithium ion secondary battery according to any one of [1] to [5], the method including:
a step of performing preliminary firing of a raw material mixture of a lithium compound, a magnesium compound, and a nickel-manganese compound, or a raw material mixture of a lithium compound and a nickel-manganese-magnesium compound at 650° C. or higher and 950° C. or lower for 10 minutes or more and 6 hours or less.

By providing the preliminary firing step, lithium is sufficiently diffused into the particles of metal composite hydroxide or metal composite oxide, and a more uniform lithium transition metal composite oxide can be obtained. Therefore, the discharge capacity and the capacity retention rate can be further increased. Accordingly, it is possible to contribute to further improvement of energy efficiency.
[8] A method for manufacturing the cathode active material for a lithium ion secondary battery according to any one of [1] to [5], the method including:
a step of performing preliminary firing of a raw material mixture of a lithium compound, a magnesium compound, a titanium compound, and a nickel-manganese compound, or a raw material mixture of a lithium compound and a nickel-manganese-magnesium-titanium compound at 650° C. or higher and 950° C. or lower for 10 minutes or more and 6 hours or less.

By providing the preliminary firing step, lithium is sufficiently diffused into the particles of metal composite hydroxide or metal composite oxide, and a more uniform lithium transition metal composite oxide can be obtained. Therefore, the discharge capacity and the capacity retention rate can be further increased. Accordingly, it is possible to contribute to further improvement of energy efficiency.
[9] The method for manufacturing the cathode active material for a lithium ion secondary battery according to [7] or [8], the method further including, subsequent to the step of performing preliminary firing, a step of performing main firing of the raw material mixture after preliminary firing at 1020° C. or higher and 1120° C. or lower for 10 minutes or more and 4 hours or less.

A cathode active material for a lithium ion secondary battery satisfying the range of the chemical composition of the lithium transition metal composite oxide represented by Formula (1) and the Mn/Ni ratio in the outer layer can be manufactured by a method including the step of performing main firing.
[10] The method for manufacturing the cathode active material for a lithium ion secondary battery according to any one of [7] to [9], the method further including, subsequent to the step of performing main firing, a step of holding an obtained lithium transition metal composite oxide at 500° C. or higher and 900° C. or lower for 1 hour or more and 20 hours or less.

By further providing the holding step (slow cooling step), a decrease in the valence of Mn in the lithium transition metal composite oxide can be suppressed, and a more stable structure can be obtained. Therefore, the discharge capacity and the capacity retention rate can be further increased. Accordingly, it is possible to contribute to further improvement of energy efficiency.

According to the cathode active material for a lithium ion secondary battery, the lithium ion secondary battery, and the method for manufacturing a cathode active material for a lithium ion secondary battery of the present invention, the discharge capacity and the capacity retention rate can be further increased.

### BRIEF DESCRIPTION OF DRAWINGS

FIG. 1 is a cross-sectional view schematically illustrating a lithium ion secondary battery according an embodiment of the present invention;

FIG. 2 is a diagram illustrating powder X-ray diffraction patterns of lithium transition metal composite oxides of Examples 1 to 3 and Comparative Example 1; and

FIG. 3 is a graph illustrating charge and discharge curves of lithium ion secondary batteries each using one of the lithium transition metal composite oxides of Examples 1 to 3 and Comparative Example 1.

### DETAILED DESCRIPTION

Hereinafter, a preferred embodiment of the present invention will be described in detail.

### [Cathode Active Material]

A cathode active material of the present embodiment contains a lithium transition metal composite oxide as a main component, and is used in a cathode of a lithium ion secondary battery. The phrase “contains a lithium transition metal composite oxide as a main component” means that the content of the lithium transition metal composite oxide is 75% by mass or more, preferably 80% by mass or more, more preferably 90% by mass or more, and still more preferably 95% by mass or more with respect to the total mass of the cathode active material, and may be 100% by mass. The cathode active material may contain components other than the main component as long as the function of the present invention is not impaired.

The cathode active material of the present embodiment may contain only one kind or two or more kinds of lithium transition metal composite oxides as long as the lithium transition metal composite oxide is contained as a main component.

In a case where the cathode active material is manufactured by using the lithium transition metal composite oxide as a main component, a composition ratio (Li:Ni:Mn:Mg:Ti) of the entirety of the lithium transition metal composite oxide is maintained also in a cathode active material to be obtained. In a case where the cathode active material obtained by using the lithium transition metal composite oxide having such a composition as a main component is used in a secondary battery, high capacity can be realized. In addition, the composition ratio of the lithium transition metal composite oxide is adjusted so as to be similar to a composition ratio required for the cathode active material to be obtained.

### <Lithium Transition Metal Composite Oxide>

The lithium transition metal composite oxide of the present embodiment has a layered rock salt type structure and is in a form of a particle having an outer layer on the surface thereof.

In the present specification, the average particle size of the particles of the lithium transition metal composite oxide (hereinafter, also simply referred to as “average particle size”) is not particularly limited, but is, for example, preferably 0.25 to 10 μm, more preferably 0.25 to 5.0 μm, and still more preferably 0.50 to 2.5 μm. When the average particle size is the above-described lower limit value or more, the productivity of the cathode active material can be further increased. When the average particle size is the above-described upper limit value or less, the electrochemical characteristics of the secondary battery can be further improved.

The average particle size means, for example, D50 measured by a laser diffraction particle size distribution measuring apparatus or the like.

### (Chemical Composition)

In a conventional lithium transition metal composite oxide (for example, LiNi_{0.5}Mn_{0.5}O₂), when the amount of Li included in a transition element in a form of solid solution therewith is increased, Ni²⁺ involved in an oxidation-reduction reaction is converted into Ni³⁺, and thus it is necessary to increase the amount of Ni used in order to increase the discharge capacity as a cathode active material. The present invention is based on the finding that, by adding Mg, or Mg and Ti as constituent elements to LiNi_{0.5}Mn_{0.5}O₂ and replacing a part of Ni_{0.5}Mn_{0.5} with Mg and Ti, the valence of Ni ions can be prevented from increasing to 3 as compared with a case of performing replacement with Li, and the atomic masses of the transition metal elements in the lithium transition metal composite oxide can be reduced. Thus, in the present invention, the amount of Ni used can be reduced while the electrochemical characteristics of the cathode active material are maintained well.

The lithium transition metal composite oxide of the present embodiment is represented by the following Formula (1).

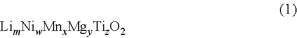

In Formula (1), m, w, x, y, and z are respectively in ranges of 1.00≤m≤1.04, 0.47<w<0.59, 0.40≤x<0.50, 0<y≤0.04, and 0≤z<0.04, and x≤w, and m+w+x+y+z=2.

In the lithium transition metal composite oxide of the present embodiment, more preferably, m, w, x, y, and z are respectively in ranges of 1.01≤m≤1.04, 0.475≤w≤0.56, 0.40≤x≤0.48, 0.005≤y≤0.03, and 0.005≤z≤0.03, and x≤w, and m+w+x+y+z=2 in Formula (1).

The chemical composition of the lithium transition metal composite oxide of the present embodiment can be determined by inductively coupled plasma (ICP) optical emission spectrometry.

### (Surface Composition)

The particle of the lithium transition metal composite oxide has an outer layer on the surface thereof.

In the present specification, the “outer layer” refers to a region up to 25 nm from the surface of the particle toward the inside of the particle. When the particle size is less than 50 nm, the particle has a single layer structure composed of the outer layer only.

In the particle of the lithium transition metal composite oxide of the present embodiment, the content rate of Mn is higher in the composition of the outer layer than in the composition of the entire particle (chemical composition of the particle). The ratio of the number of Mn atoms to the number of Ni atoms (Mn/Ni ratio) in the outer layer of the lithium transition metal composite oxide of the present embodiment is 1.0 or more and 1.5 or less, preferably 1.0 or more and 1.4 or less, and more preferably 1.0 or more and 1.3 or less. When the Mn/Ni ratio is within the above numerical range, movement of lithium ions is not inhibited, and the charge and discharge capacity of the secondary battery becomes high in a case of use as a cathode active material.

The Mn/Ni ratio can be determined by quantitative analysis of X-ray photoelectron spectroscopy (XPS). According to XPS, the composition of the transition metal element on the surface of the entire particle can be analyzed. That is, an analysis result obtained by XPS does not indicate a local composition of the entire surface of one particle, but indicates a composition of the entire surface of the particle.

A ratio (hereinafter, also referred to as an “outer layer/entire particle ratio of the Mn/Ni ratio”) of the ratio of the number of Mn atoms to the number of Ni atoms (Mn/Ni ratio) in the outer layer of the lithium transition metal composite oxide of the present embodiment to the ratio of the number of Mn atoms to the number of Ni atoms (Mn/Ni ratio) in the entire particle (chemical composition of the particle) is preferably 1.0 or more and 2.0 or less, more preferably 1.0 or more and 1.8 or less, and still more preferably 1.0 or more and 1.5 or less. When the outer layer/entire particle ratio of the Mn/Ni ratio is within the above numerical range, the surface becomes manganese-rich, and the discharge capacity can be further increased even if the content of Ni is reduced.

The outer layer/entire particle ratio of the Mn/Ni ratio can be determined by quantitative analysis of XPS.

The ratio of the number of Mg atoms to the number of Ni atoms (Mg/Ni ratio) in the outer layer of the lithium transition metal composite oxide of the present embodiment is preferably 0.02 or more and 0.15 or less, more preferably 0.02 or more and 0.12 or less, and still more preferably 0.02 or more and 0.11 or less. When the Mg/Ni ratio is within the above numerical range, release of oxygen from the cathode active material at the time of initial charge can be suppressed. Therefore, the discharge capacity of the secondary battery can be further increased.

The Mg/Ni ratio can be determined by quantitative analysis of XPS.

A ratio (hereinafter, also referred to as an “outer layer/entire particle ratio of the Mg/Ni ratio”) of the ratio of the number of Mg atoms to the number of Ni atoms (Mg/Ni ratio) in the outer layer of the lithium transition metal composite oxide of the present embodiment to the ratio of the number of Mg atoms to the number of Ni atoms (Mg/Ni ratio) in the entire particle (chemical composition of the particle) is preferably 1.0 or more and 5.0 or less, more preferably 1.0 or more and 4.5 or less, and still more preferably 1.0 or more and 4.0 or less. When the outer layer/entire particle ratio of the Mg/Ni ratio is within the above numerical range, the surface becomes magnesium-rich, an increase in Ni valence can be suppressed, and the discharge capacity can be further increased.

The outer layer/entire particle ratio of the Mg/Ni ratio can be determined by quantitative analysis of XPS.

The lithium transition metal composite oxide of the present embodiment preferably contains Ti. When titanium (Ti) having an atomic mass smaller than that of Ni or Mn is contained, the atomic masses of the transition metal elements in the lithium transition metal composite oxide can be further reduced.

In a case where the lithium transition metal composite oxide of the present embodiment contains Ti, the ratio of the number of Ti atoms to the number of Ni atoms (Ti/Ni ratio) in the outer layer of the lithium transition metal composite oxide is preferably 0.02 or more and 0.25 or less, more preferably 0.02 or more and 0.20 or less, and still more preferably 0.02 or more and 0.18 or less. When the Ti/Ni ratio is within the above numerical range, an increase in the Ni valence can be suppressed, and the atomic masses of the transition metal elements in the lithium transition metal composite oxide can be reduced. Therefore, the discharge capacity of the secondary battery can be further increased.

The Ti/Ni ratio can be determined by quantitative analysis of XPS.

In the case where the lithium transition metal composite oxide of the present embodiment contains Ti, a ratio (hereinafter, also referred to as an “outer layer/entire particle ratio of the Ti/Ni ratio”) of the ratio of the number of Ti atoms to the number of Ni atoms (Ti/Ni ratio) in the outer layer of the lithium transition metal composite oxide to the ratio of the number of Ti atoms to the number of Ni atoms (Ti/Ni ratio) in the entire particle (chemical composition of the particle) is preferably 1.0 or more and 20.0 or less, more preferably 1.0 or more and 18.0 or less, and still more preferably 1.0 or more and 15.0 or less. When the outer layer/entire particle ratio of the Ti/Ni ratio is within the above numerical range, the surface becomes titanium-rich, an increase in the Ni valence can be suppressed, and the discharge capacity can be further increased.

The outer layer/entire particle ratio of the Ti/Ni ratio can be determined by quantitative analysis of XPS.

The particles of the lithium transition metal composite oxide of the present embodiment may be primary particles or secondary particles. From the viewpoint that relatively dense particles can be obtained, the particles of the lithium transition metal composite oxide are preferably secondary particles in which a plurality of primary particles are aggregated with each other.

### (Lattice Constant)

The lithium transition metal composite oxide of the present embodiment is a layered compound of a rhombohedral crystal system, and has a crystal structure of a space group R-3m. Among lattice constants of the lithium transition metal composite oxide, the a-axis length is preferably 2.881 Å to 2.893 Å. The c-axis length is preferably 14.28 Å to 14.31 Å. The ratio represented by c-axis length/a-axis length (hereinafter, also referred to as “c/a”) is preferably 4.948 to 4.958. When the lattice constants are within the above-described ranges, in the lithium transition metal composite oxide, lithium ions are likely to be diffused in primary particles, and resistance is low.

The lattice constants of the crystal can be determined by a least square method by measuring an X-ray diffraction pattern of the lithium transition metal composite oxide and using each index and plane spacing thereof.

### (X-Ray Diffraction (XRD) Pattern)

In the cathode active material of the present embodiment, it is preferable that in an X-ray diffraction (XRD) pattern obtained using a Cu radiation source, diffraction peaks of a 108 plane and a 110 plane in a space group R-3m be split, and a full width at half maximum of the diffraction peak of the 110 plane be 0.10° or more and 0.21° or less. Split of the diffraction peaks of the 108 plane and the 110 plane in the XRD pattern indicates that Ni, Mn, and Mg, or Ni, Mn, Mg, and Ti in the lithium transition metal composite oxide are uniformly dispersed without undergoing phase separation. This means that the lithium transition metal composite oxide of the present embodiment certainly has the chemical composition represented by Formula (1).

In the present specification, “a diffraction peak is split” means that the diffraction peak has two or more vertices.

The XRD pattern of the cathode active material of the present embodiment can be determined, for example, by a method indicated in Examples using Cu (copper) as a target to be irradiated with an electron beam and using Kα rays as characteristic X-rays.

In the X-ray diffraction pattern using the Cu radiation source, the full width at half maximum of the diffraction peak of the 110 plane in the space group R-3m is preferably 0.10° or more and 0.21° or less, and more preferably 0.10° or more and 0.18° or less. The fact that the full width at half maximum of the diffraction peak of the 110 plane is within the above numerical range means that tailing of the diffraction peak of the 110 plane in the space group R-3m does not occur.

The full width at half maximum of the diffraction peak is determined by analyzing the XRD pattern.

### [Method for Manufacturing Cathode Active Material]

The cathode active material of the present embodiment contains the above-described lithium transition metal composite oxide as a main component. As a lithium source of the lithium transition metal composite oxide, it is possible to use a known compound such as a hydroxide such as lithium hydroxide monohydrate (LiOH·H₂O), a carbonate such as lithium carbonate (Li₂CO₃), or an acetate such as lithium acetate (CH₃COOLi) and lithium acetate dihydrate (CH₃COOLi·2H₂O), and there is no particular limitation. As compounds of a nickel source, a manganese source, a magnesium source, and a titanium source of the transition metal, known oxides, hydroxides, or metal salts of nickel, manganese, magnesium, and titanium can be widely used, and there is no particular limitation.

For example, as the nickel compound, nickel hydroxide (Ni(OH)₂), nickel(II) chloride (NiCl₂), nickel(II) chloride hexahydrate (NiCl₂·6H₂O), and nickel(II) nitrate hexahydrate (Ni(NO₃)₂·6H₂O) can be used, but there is no limitation thereto.

As the manganese compound, manganese(II) chloride (MnCl₂), manganese(II) chloride tetrahydrate (MnCl₂·4H₂O), manganese carbonate hexahydrate (MnCO₃·6H₂O), manganese(II) nitrate hexahydrate (Mn(NO₃)₂·6H₂O) and the like can be used, but there is no limitation thereto.

As the magnesium compound, magnesium oxide (MgO), magnesium hydroxide (Mg (OH)₂), magnesium chloride hexahydrate (MgCl₂·6H₂O), magnesium carbonate (MgCO₃), magnesium sulfate heptahydrate (MgSO₄·7H₂O), and the like can be used, but there is no limitation thereto.

As the titanium compound, titanium (IV) dioxide (TiO₂), titanium (IV) sulfate (Ti(SO₄)₂), and the like can be used, but there is no limitation thereto.

The transition metal compounds can be used alone and as a composite hydroxide (for example, nickel-manganese-magnesium composite hydroxide) or the like by using a coprecipitation method or the like.

The lithium transition metal composite oxide of the present embodiment can be synthesized by using a known method. For example, the synthesis can be performed as follows: a composite hydroxide or a composite oxide of a nickel compound and a manganese compound is prepared as an intermediate compound, the intermediate compound, a magnesium compound, and a lithium compound are mixed to obtain a raw material mixture, and the raw material mixture is heat-treated (for example, fired) at a predetermined temperature for a predetermined time in a predetermined atmosphere. In addition, the synthesis can also be performed as follows: a composite hydroxide or a composite oxide of a nickel compound, a manganese compound, and a magnesium compound is prepared as an intermediate compound, the intermediate compound and a lithium compound are mixed to obtain a raw material mixture, and the raw material mixture is heat-treated (for example, fired) at a predetermined temperature for a predetermined time in a predetermined atmosphere.

Alternatively, a titanium compound may be mixed with these intermediate compounds, and a composite hydroxide or a composite oxide of a nickel compound, a manganese compound, a magnesium compound, and a titanium compound may be prepared as the intermediate compound.

The raw material mixture is preferably subjected to firing in advance (hereinafter, also referred to as “preliminary firing”) at a treatment temperature lower than that of the heat treatment before performing the heat treatment. By performing the preliminary firing, lithium is sufficiently diffused into the particles of metal composite hydroxide or metal composite oxide, and a more uniform lithium transition metal composite oxide can be obtained.

It is preferable that the lithium transition metal composite oxide obtained in the heat treatment be further held in a predetermined temperature range for a predetermined time by a slow cooling step. Since slow cooling conditions vary depending on treatment conditions (for example, a heat treatment atmosphere such as an oxygen atmosphere or an air atmosphere) and the like, it is preferable to perform appropriate adjustment. The present inventors have found that by appropriately selecting the heat treatment conditions and the slow cooling conditions, the transition metals of the lithium transition metal composite oxide are uniformly dispersed, and the Mn/Ni ratio on the particle surface can be increased. Hereinafter, a method for manufacturing a cathode active material of the present embodiment will be described in more detail with reference to an aspect.

### <Main Firing Step>

A main firing step is a step of firing the raw material mixture at 1020° C. or higher and 1120° C. or lower for 10 minutes or more and 4 hours or less.

In the main firing step, first, a predetermined amount of a magnesium compound and a predetermined amount of a lithium compound are added to a nickel-manganese compound as an intermediate, and the resulting mixture is dispersed and mixed in a solvent such as ethanol. Note that, a predetermined amount of the intermediate compound, a predetermined amount of a magnesium compound, and a predetermined amount of a lithium compound may be mixed not only by wet mixing using a solvent but also by dry mixing not using a solvent. For example, in a case of synthesizing Li_{1.02}Ni_{0.48}Mn_{0.48}Mg_{0.020}O₂ by using magnesium oxide (MgO) as a magnesium compound and lithium carbonate (Li₂CO₃) as a lithium compound, Li₂CO₃ is preferably weighed more than the stoichiometric ratio by 1% by mass to 5% by mass, for example, 4% by mass.

The nickel-manganese compound can be synthesized by a known method. In a case where the nickel-manganese compound is a hydroxide, for example, nickel sulfate hexahydrate (NiSO₄·6H₂O) and manganese sulfate pentahydrate (MnSO₄·5H₂O) are weighed so that a molar ratio of Ni:Mn becomes 1:1, pure water is added thereto to dissolve the compounds, and an aqueous alkali solution is added dropwise to the aqueous sulfate solution, and thereby the compounds can be coprecipitated as a nickel-manganese composite hydroxide.

As the intermediate compound, a nickel-manganese-magnesium compound may be used instead of the nickel-manganese compound. For example, a predetermined amount of a lithium compound is added to the nickel-manganese-magnesium compound, and the resulting mixture is dispersed and mixed in a solvent such as ethanol. Note that, a predetermined amount of the nickel-manganese-magnesium compound, and a predetermined amount of a lithium compound may be mixed not only by wet mixing using a solvent but also by dry mixing not using a solvent. For example, in a case of synthesizing Li_{1.02}Ni_{0.48}Mn_{0.48}Mg_{0.020}O₂ by using lithium carbonate (Li₂CO₃) as a lithium compound, Li₂CO₃ is preferably weighed more than the stoichiometric ratio by 1% by mass to 5% by mass, for example, 4% by mass.

The nickel-manganese-magnesium compound can be synthesized using a known method. In a case where the nickel-manganese-magnesium compound is a hydroxide, for example, nickel sulfate hexahydrate (NiSO₄·6H₂O), manganese sulfate pentahydrate (MnSO₄·5H₂O), and magnesium sulfate heptahydrate (MgSO₄·7H₂O) are weighed so that the molar ratio of Ni:Mn:Mg becomes 48:48:2, pure water is added thereto to dissolve the compounds, an aqueous alkali solution is added dropwise to the aqueous sulfate solution, and thereby the compounds can be coprecipitated as a nickel-manganese-magnesium composite hydroxide.

As the intermediate compound, a titanium compound may be further used in addition to the lithium compound and the magnesium compound.

In addition, a nickel-manganese-magnesium-titanium compound may be used instead of the nickel-manganese-magnesium compound. The nickel-manganese-magnesium-titanium compound can be synthesized by a method similar to that for the nickel-manganese-magnesium compound, for example, by using titanium (IV) sulfate (Ti(SO₄)₂) as a titanium compound.

As a precursor, a raw material mixture of a lithium compound, a magnesium compound, and a nickel-manganese compound, a raw material mixture of a lithium compound and a nickel-manganese-magnesium compound, a raw material mixture of a lithium compound, a magnesium compound, a titanium compound, and a nickel-manganese compound, or a raw material mixture of a lithium compound and a nickel-manganese-magnesium-titanium compound is pulverized into a preferable size, mixed, and then filled in, for example, a crucible to perform firing (hereinafter, also referred to as “main firing”) of the raw material mixture. As the crucible, an alumina square sagger, an alumina crucible, a platinum crucible, a gold crucible, or the like is used. In the main firing of the raw material mixture, for example, a firing furnace or a roller hearth kiln is used.

The raw material mixture put into the sagger or the crucible is heated to reach a firing temperature at a temperature-rising rate of 5° C./min to 25° C./min, preferably 10° C./min to 25° C./min. A firing atmosphere is not particularly limited, and examples thereof include the atmosphere (under an air atmosphere), and an oxygen flow. The firing atmosphere is preferably the oxygen flow.

The firing temperature is preferably 1020° C. or higher and 1120° C. or lower, and more preferably 1045° C. or higher and 1095° C. or lower. The firing time is preferably 10 minutes or more and 4 hours or less, more preferably 20 minutes or more and 3 hours or less, still more preferably 30 minutes or more and 2 hours or less, and particularly preferably 30 minutes or more and 1 hour or less.

The firing time can be appropriately set depending on the firing temperature. The firing time represents a time for holding the firing temperature.

### <Preliminary Firing Step>

A preliminary firing step is a step of firing the raw material mixture at 650° C. or higher and 950° C. or lower, i.e., at a temperature lower than the above firing temperature, for 10 minutes or more and 6 hours or less.

In the preliminary firing step, a firing furnace or a roller hearth kiln similar to that in the main firing step can be used.

The firing atmosphere in the preliminary firing step is not particularly limited, and can be a firing atmosphere similar to that in the main firing step.

The firing temperature in the preliminary firing step is preferably 650° C. or higher and 950° C. or lower, and more preferably 750° C. or higher and 850° C. or lower.

The firing time in the preliminary firing step is preferably 10 minutes or more and 6 hours or less, more preferably 20 minutes or more and 4 hours or less, still more preferably 30 minutes or more and 2 hours or less, and particularly preferably 30 minutes or more and 1 hour or less.

### <Slow Cooling Step>

A slow cooling step is a step of holding the obtained lithium transition metal composite oxide at 500° C. or more and 900° C. or less for 1 hour or more and 20 hours or less, subsequent to the main firing step.

In the slow cooling step, powder obtained after the firing step is cooled so as to reach 500 to 900° C., for example, at a temperature-falling rate of 5° C./min to 25° C./min, preferably 10° C./min to 25° C./min, and then the powder is held at 500 to 900° C. for 1 hour or more and 20 hours or less. The atmosphere for holding the powder at 500 to 900° C. is not particularly limited, and examples thereof include the atmosphere (under an air atmosphere), an air flow, and an oxygen flow.

The temperature at which the powder is held in the slow cooling step is preferably 500° C. or higher and 900° C. or lower, and more preferably 600° C. or higher and 800° C. or lower.

The time for holding the powder in the slow cooling step is preferably 1 hour or more and 20 hours or less, more preferably 2 hours or more and 15 hours or less, and still more preferably 3 hours or more and 10 hours or less.

The slow cooling step may be performed two or more times as long as the temperature for the holding is lowered stepwise. The cathode active material of the present embodiment can further increase the Mn/Ni ratio on the surface of the particles of the lithium transition metal composite oxide by appropriately selecting the slow cooling conditions.

### [Lithium Ion Secondary Battery]

The lithium ion secondary battery (hereinafter, also simply referred to as a “secondary battery”) of the present embodiment includes a cathode, an anode, and an electrolyte, and the cathode contains a cathode active material containing the above-described lithium transition metal composite oxide as a main component. The secondary battery of the present embodiment may include other battery elements as necessary.

In the secondary battery of the present embodiment, a known battery element of a secondary battery can be employed as it is except that the cathode contains a cathode active material containing the above-described lithium transition metal composite oxide as a main component. The secondary battery of the present embodiment may have any of coin type, button type, cylindrical type, square type, and laminate type configurations. In addition, the secondary battery of the present embodiment is applicable to a wide range of applications such as mobile devices including mobile phones and laptop computers, and in-vehicle applications.

Hereinafter, with respect to the secondary battery of the present embodiment, a secondary battery (coin-type secondary battery) using an electrolytic solution will be described. Each battery element to be described below can be similarly applied to an all-solid-state secondary battery not using an electrolytic solution, as well.

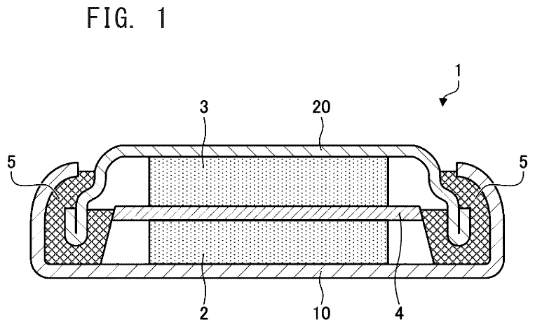

FIG. 1 is a cross-sectional view schematically illustrating a secondary battery according to the present embodiment. FIG. 1 illustrates an example in which the secondary battery of the present embodiment is a coin-type secondary battery. As illustrated in FIG. 1, a secondary battery 1 of the present embodiment includes an anode can (anode terminal) 20, an anode 3, a separator 4 impregnated with an electrolytic solution, an insulating packing (gasket) 5, a cathode 2, and a cathode can 10.

The cathode can 10 is disposed on a lower side of the separator 4, the anode can 20 is disposed on an upper side of the separator 4, and the outer shape of the secondary battery 1 is formed by the cathode can 10 and the anode can 20. The cathode 2 and the anode 3 are provided between the cathode can 10 and the anode can 20 with the separator 4 impregnated with an electrolytic solution interposed therebetween, and the cathode 2 and the anode 3 are separated from each other by the separator 4. The cathode can 10 and the anode can 20 are electrically insulated from each other by the insulating packing 5.

In the secondary battery 1, a cathode mixture is prepared by blending a conductive agent, a binder, and the like with the cathode active material of the present embodiment as necessary, and the cathode mixture is pressure-bonded to a current collector (not illustrated), and thereby the cathode 2 can be produced.

As the current collector, a stainless steel mesh, aluminum foil, or the like can be preferably used. As the conductive agent, acetylene black, ketjen black, or the like can be preferably used. As the binder, tetrafluoroethylene, polyvinylidene fluoride, or the like can be preferably used.

Blending of the cathode active material, the conductive agent, and the binder in the cathode mixture is not particularly limited. The content of the conductive agent in the cathode mixture is preferably 1% by mass to 15% by mass, and more preferably 0.1% by mass to 5% by mass. The content of the binder in the cathode mixture is preferably 0.1% by mass to 10% by mass, and more preferably 0.1% by mass to 5% by mass. It is preferable to blend the cathode active material, the conductive agent, and the binder such that the remainder (a portion other than the cathode active material and the conductive agent) in the cathode mixture becomes the cathode active material.

In the secondary battery 1, as the anode 3 with respect to the cathode 2, it is possible to employ a known material that functions as an anode active material, for example, a metal-based material such as metallic lithium and a lithium alloy, a carbon-based material such as graphite and mesocarbon microbeads (MCMB), and a silicon-based material such as silicon (Si), a Si alloy, and silicon oxide, and is capable of intercalating and deintercalating lithium.

Known battery elements can be employed as the separator 4 and a battery container (the cathode can 10 and the anode can 20).

As the electrolyte, a known electrolytic solution, a known solid electrolyte, or the like can be employed. As the electrolytic solution, for example, a solution obtained by dissolving an electrolyte such as lithium perchlorate or lithium hexafluorophosphate in a solvent such as ethylene carbonate (EC), dimethyl carbonate (DMC), propylene carbonate (PC), or diethyl carbonate (DEC) can be used.

In addition, the all-solid-state secondary battery can have a structure similar to that of a known all-solid-state lithium ion secondary battery except that a cathode active material containing the above-described lithium transition metal composite oxide as a main component is used.

In the case of the all-solid-state secondary battery, as the electrolyte, for example, solid electrolytes such as a polymer-based solid electrolyte such as a polyethylene oxide-based polymer compound and a polymer compound including at least one or more of a polyorganosiloxane chain and a polyoxyalkylene chain, a sulfide-based solid electrolyte, and an oxide-based solid electrolyte can be used.

For the cathode of the all-solid-state secondary battery, for example, a cathode mixture containing a solid electrolyte in addition to the cathode active material, the conductive agent, and the binder can be carried on a cathode current collector of, for example, aluminum, nickel, or stainless steel.

In the secondary battery 1 of the present embodiment, since the cathode 2 contains a cathode active material containing the above-described lithium transition metal composite oxide as a main component, the discharge capacity and the capacity retention rate can be further increased.

### EXAMPLES

Hereinafter, examples of the present invention will be described, but the present invention is not limited to the examples below.

### Example 1

(Synthesis of Lithium-Nickel-Manganese-Magnesium-Titanium Composite Oxide: Li_{1.00}Ni_{0.48}Mn_{0.48}Mg_{0.027}Ti_{0.013}O₂) Li₂CO₃ (manufactured by Kojundo Chemical Lab. Co., Ltd.), Ni_{0.5}Mn_{0.5}(OH)₂, MgO (manufactured by FUJIFILM Wako Pure Chemical Corporation), and TiO₂ (manufactured by FUJIFILM Wako Pure Chemical Corporation) were weighed so that a ratio of Li:Ni:Mn:Mg:Ti becomes 1.00:0.48:0.48:0.027:0.013 in terms of a molar ratio, and in consideration of Li evaporation, Li₂CO₃ was weighed more than the stoichiometric ratio by 4% by mass. The total mass of Li₂CO₃, Ni_{0.5}Mn_{0.5}(OH)₂, MgO, and TiO₂ was set to 50 g. The materials were dispersed and mixed in ethanol in a mortar. Thereafter, the mixture was filled in an alumina square sagger. The raw material mixture filled in the platinum crucible was heated by using a firing furnace in the air at a temperature-rising rate of 10° C./min and subjected to preliminary firing at 775° C. for 60 minutes, and then the obtained powder was left to stand until the temperature of the powder reached room temperature (25° C.). Thereafter, the obtained powder was heated at a temperature-rising rate of 10° C./min, and subjected to main firing at 1070° C. for 30 minutes.

The powder after the main firing was cooled so as to reach 750° C. at a temperature-falling rate of 10° C./min, and then the powder was held at 750° C. for 5 hours in the air. Next, the powder was cooled at a temperature-falling rate of 10° C./min so as to reach 650° C., and then the powder after the cooling was held at 550° C. for 5 hours in the air. Thereafter, the powder was left to stand until the temperature of the powder reached room temperature (25° C.) to obtain a lithium-nickel-manganese-magnesium-titanium composite oxide of Example 1.

### Example 2

(Synthesis of Lithium-Nickel-Manganese-Magnesium-Titanium Composite Oxide: Li_{1.02}Ni_{0.56}Mn_{0.40}Mg_{0.010}Ti_{0.010}O₂)

A lithium-nickel-manganese-magnesium-titanium composite oxide of Example 2 was obtained in the same manner as in Example 1 except that the respective compounds were weighed so as to have the molar ratios described in Table 1, and the main firing conditions were set to the conditions shown in Table 1.

### Example 3

(Synthesis of Lithium-Nickel-Manganese-Magnesium Composite Oxide: Li_{1.02}Ni_{0.48}Mn_{0.48}Mg_{0.020}O₂)

A lithium-nickel-manganese-magnesium composite oxide of Example 3 was obtained in the same manner as in Example 1 except that the respective compounds were weighed so as to have the molar ratios described in Table 1.

### Comparative Example 1

(Synthesis of Lithium-Nickel-Manganese-Titanium Composite Oxide: Li_{1.02}Ni_{0.48}Mn_{0.48}Ti_{0.020}O₂)

A lithium-nickel-manganese-titanium composite oxide of Comparative Example 1 was obtained in the same manner as in Example 1 except that the respective compounds were weighed so as to have the molar ratios described in Table 1, and the main firing conditions were set to the conditions shown in Table 1.

### (Analysis)

Chemical compositions of samples obtained in Examples 1 to 3 and Comparative Example 1 were analyzed by an ICP optical emission spectrometer (trade name: Agilent 5110 VDV, manufactured by Agilent Technologies, Inc.). The results are shown in Table 1. In the table, “-” means that the element is not contained.

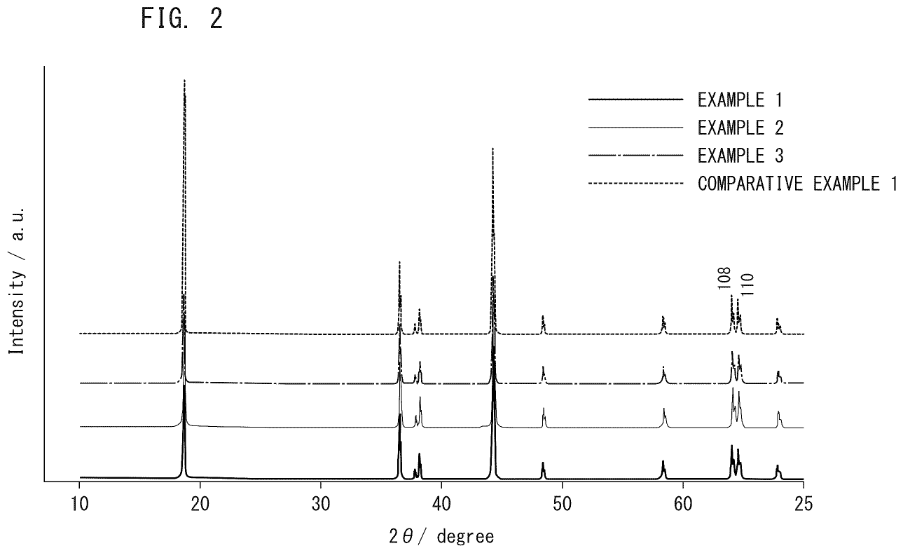

X-ray diffraction (XRD) patterns of the samples obtained in Examples 1 to 3 and Comparative Example 1 were measured with a powder X-ray diffractometer (trade name: SmartLab, manufactured by Rigaku Corporation). Cu (copper) was used as a target to be irradiated with an electron beam, and Kα rays were used as characteristic X-rays. The lattice constants were determined by a least square method using each index of the obtained XRD patterns and plane spacing thereof. The lattice constants were determined with the space group R-3m of the obtained samples. The powder X-ray diffraction patterns are illustrated in FIG. 2. The lattice constant values are shown in Table 1.

By quantitative analysis with an X-ray photoelectron spectroscopy (XPS) analyzer (trade name: K-Alpha⁺, manufactured by Thermo Fisher Scientific), the compositions of outer layers of the samples obtained in Examples 1 to 3 and Comparative Example 1 were analyzed. The Mn/Ni ratio, the Mg/Ni ratio, and the Ti/Ni ratio in the entire particle (the central portion and the outer layer), and the Mn/Ni ratio, the Mg/Ni ratio, and the Ti/Ni ratio in the outer layer are shown in Table 1. In the table, “-” means that Mg or Ti is not contained. Measurement conditions of XPS measurement are shown below.

### <<XPS Measurement Conditions>>

Model used: manufactured by Thermo Fisher Scientific, K-Alpha⁺(trade name)
Irradiation X-ray: single crystal spectroscopic AlKα (12 keV, 72 W)
X-ray spot diameter: 400 μm
Neutralization electron gun: used
Reference spectrum: C—C, C—H 284.6 eV
Detection depth: 6 to 7 nm

TABLE 1

| | | | | | | | | Comparative | |
|---|---|---|---|---|---|---|---|---|---|
| | | Example 1 | | Example 2 | | Example 3 | | example 1 | |
| Chemical | Li | 1.00 | | 1.02 | | 1.02 | | 1.02 | |
| composition | Ni | 0.48 | | 0.56 | | 0.48 | | 0.48 | |
| (ICP) | Mn | 0.48 | | 0.40 | | 0.48 | | 0.48 | |
| | Mg | 0.027 | | 0.010 | | 0.020 | | — | |
| | Ti | 0.013 | | 0.010 | | — | | 0.020 | |
| Main firing condition | | 1070° C. 30 min | | 1050° C. 30 min | | 1070° C. 30 min | | 1075° C. 30 min | |
| Lattice | a(Å) | 2.88693 | (10) | 2.88501 | (7) | 2.88388 | (7) | 2.88693 | (7) |
| constant | c(Å) | 14.2971 | (6) | 14.2838 | (5) | 14.2907 | (5) | 14.2981 | (4) |

| | c/a | 4.9524 | 4.9510 | 4.9554 | 4.9527 |
|---|---|---|---|---|---|
| Full width at half maximum of | | 0.14 | 0.14 | 0.15 | 0.14 |
| diffraction peak of 110 plane (*) | | | | | |
| Mn/Ni ratio | Entire particle | 1.00 | 0.70 | 1.00 | 1.00 |
| | Outer layer | 1.21 | 1.00 | 1.03 | 1.22 |
| | Outer layer/ | 1.21 | 1.43 | 1.03 | 1.22 |
| | entire particle | | | | |
| Mg/Ni ratio | Entire particle | 0.056 | 0.018 | 0.042 | — |
| | Outer layer | 0.091 | 0.062 | 0.084 | — |
| | Outer layer/ | 1.63 | 3.44 | 2.00 | — |
| | entire particle | | | | |
| Ti/Ni ratio | Entire particle | 0.028 | 0.018 | — | 0.042 |
| | Outer layer | 0.072 | 0.250 | — | 0.120 |
| | Outer layer/ | 2.57 | 13.89 | — | 2.86 |
| | entire particle | | | | |

| | | | | |
|---|---|---|---|---|
| Initial discharge capacity (mAhg⁻¹) | 192 | 192 | 188 | 200 |
| Capacity retention rate (%) | 94 | 92 | 91 | 83 |

From the XRD patterns illustrated in FIG. 2, it was confirmed that in the samples obtained in Examples 1 to 3 and Comparative Example 1, both of two diffraction peaks of the 108 plane and the 110 plane in the space group R-3m were split. From the above, it can be seen that in the samples obtained in Examples 1 to 3 and Comparative Example 1, Ni, Mn, and Mg, or Ni, Mn, Mg, and Ti in the lithium transition metal composite oxide are uniformly dispersed without undergoing phase separation.

### [Production of Lithium Ion Secondary Battery]

The lithium-nickel-manganese-magnesium-titanium composite oxides of Examples 1 to 2, the lithium-nickel-manganese-magnesium composite oxide of Example 3, and the lithium-nickel-manganese-titanium composite oxide of Comparative Example 1 each as a cathode active material, acetylene black (AB) as a conductive agent, and polyvinylidene fluoride (PVDF) as a binder were mixed so as to be in a weight ratio of 96:2:2 by using N-methyl-2-pyrrolidone (M4P) as a solvent to produce a slurry. Thereafter, aluminum foil having a thickness of 15 μm was coated with the slurry and was dried to produce a cathode having a diameter of 16.5ϕ. A coating area density was set to 10.0 mg/cm², and a volume density was set to 2.8 g/cm³. With respect to the cathode, a lithium metal having a thickness of 200 μm and a diameter of 18 #was used as a counter electrode, and a polyethylene microporous film having a thickness of 20 μm and a diameter of 19.4 #was used as a separator. A 1.2 mol/L solution obtained by dissolving lithium hexafluorophosphate (LiPF₆) in a mixed solvent of ethylene carbonate (EC), dimethyl carbonate (DMC), and ethyl methyl carbonate (EMC) (volume ratio: 3:4:3) was used as an electrolytic solution, and a lithium ion secondary battery (2032 coin type cell) having the structure illustrated in FIG. 1 was produced. The battery was produced in accordance with a known cell configuration and assembly method.

### [Charge and Discharge Test]

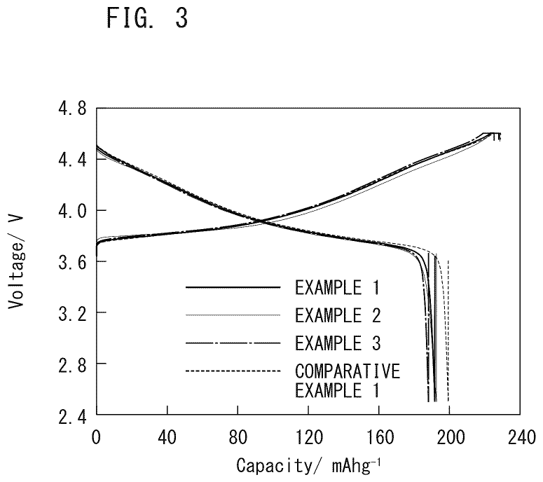

Each of the produced lithium ion secondary batteries was subjected to a charge and discharge test at a constant current at a rate of 0.05 C (1 C: 250 mA/g), a current density of 12.5 mA/g, a cutoff potential of 4.6 V to 2.75 V under a temperature condition of 25° C. to evaluate an initial discharge capacity. The charge and discharge test was started from charge. The values of the initial discharge capacity are shown in Table 1, and the charge and discharge curves are illustrated in FIG. 3.

FIG. 3 illustrates a voltage change at the time of discharge in which a cell voltage decreases as the capacity increases, and a voltage change at the time of charge in which the cell voltage increases as the capacity increases.

It was found that as illustrated in FIG. 3, the lithium ion secondary battery of each example had the initial discharge capacity shown in Table 1, and had a higher capacity than a conventional lithium ion secondary battery. The reason therefor is presumed as follows: by adjusting the composition of the lithium transition metal composite oxide and adjusting the firing conditions in the firing step, the configuration of the lithium transition metal composite oxide becomes more stable, elution of Ni into the electrolytic solution can be suppressed, and the Mn/Ni ratio in the outer layers of the particles of the lithium transition metal composite oxide can be further increased.

### [Cycle Test]

After the evaluation of the initial discharge capacity, each of the produced lithium ion secondary batteries was subjected to a cycle test 50 times at a current density of 50.0 mA/g and a cutoff potential of 4.3 V to 2.75 V under a temperature condition of 25° C., and a capacity retention rate (discharge capacity at the 50th cycle/discharge capacity at the first cycle) was evaluated. The charge and discharge test was started from charge. The results are shown in Table 1. A higher capacity retention rate indicates better cycle characteristics.

As shown in Table 1, the lithium ion secondary batteries of Examples 1 to 3 to which the present invention was applied exhibited a high capacity retention rate of 90% or more.

On the other hand, the capacity retention rate of the lithium ion secondary battery of Comparative Example 1 which did not contain magnesium in the chemical composition and did not contain the lithium transition metal composite oxide represented by Formula (1) was 83%.

From the above results, it was found that the present invention can provide a cathode active material for a lithium ion secondary battery capable of further increasing the discharge capacity and the capacity retention rate, and a lithium ion secondary battery containing the cathode active material.

What is claimed is:

1. A cathode active material for a lithium ion secondary battery containing a lithium transition metal composite oxide as a main component, wherein
the lithium transition metal composite oxide is in a form of a particle having an outer layer on a surface of the particle,
the lithium transition metal composite oxide is represented by the following Formula (1): 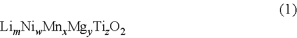
wherein m, w, x, y, and z are respectively in ranges of 1.00≤m≤1.04, 0.47<w<0.59, 0.40≤x<0.50, 0<y≤0.04, and 0≤z<0.04, and x≤w, and m+w+x+y+z=2, and
a ratio of a number of Mn atoms to a number of Ni atoms (Mn/Ni ratio) in the outer layer is 1.0 or more and 1.5 or less.

2. The cathode active material for a lithium ion secondary battery according to claim 1, wherein a ratio of a number of Mg atoms to the number of Ni atoms (Mg/Ni ratio) in the outer layer is 0.02 or more and 0.15 or less, and a ratio of the ratio of the number of Mg atoms to the number of Ni atoms (Mg/Ni ratio) in the outer layer to the ratio of the number of Mg atoms to the number of Ni atoms (Mg/Ni ratio) in the entire particle is 1.0 or more and 5.0 or less.

3. The cathode active material for a lithium ion secondary battery according to claim 1, wherein Ti is contained, a ratio of a number of Ti atoms to the number of Ni atoms (Ti/Ni ratio) in the outer layer is 0.02 or more and 0.25 or less, and a ratio of the ratio of the number of Ti atoms to the number of Ni atoms (Ti/Ni ratio) in the outer layer to the ratio of the number of Ti atoms to the number of Ni atoms (Ti/Ni ratio) in the entire particle is 1.0 or more and 20.0 or less.

4. The cathode active material for a lithium ion secondary battery according to claim 1, wherein in an X-ray diffraction pattern obtained using a Cu radiation source, diffraction peaks of a 108 plane and a 110 plane in a space group R-3m are split, and a full width at half maximum of the diffraction peak of the 110 plane is 0.10° or more and 0.21° or less.

5. The cathode active material for a lithium ion secondary battery according to claim 1, wherein among lattice constants of the lithium transition metal composite oxide in a space group R-3m, an a-axis length is 2.881 Å to 2.893 Å, a c-axis length is 14.28 Å to 14.31 Å, and c/a is 4.948 to 4.958.

6. A lithium ion secondary battery comprising:
a cathode; an anode; and an electrolyte, wherein the cathode contains the cathode active material for a lithium ion secondary battery according to claim 1.

7. A method for manufacturing the cathode active material for a lithium ion secondary battery according to claim 1, the method comprising:
a step of performing preliminary firing of a raw material mixture of a lithium compound, a magnesium compound, and a nickel-manganese compound, or a raw material mixture of a lithium compound and a nickel-manganese-magnesium compound at 650° C. or higher and 950° C. or lower for 10 minutes or more and 6 hours or less.

8. A method for manufacturing the cathode active material for a lithium ion secondary battery according to claim 1, the method comprising:
a step of performing preliminary firing of a raw material mixture of a lithium compound, a magnesium compound, a titanium compound, and a nickel-manganese compound, or a raw material mixture of a lithium compound and a nickel-manganese-magnesium-titanium compound at 650° C. or higher and 950° C. or lower for 10 minutes or more and 6 hours or less.

9. The method for manufacturing the cathode active material for a lithium ion secondary battery according to claim 7, the method further comprising, subsequent to the step of performing preliminary firing, a step of performing main firing of the raw material mixture after preliminary firing at 1020° C. or higher and 1120° C. or lower for 10 minutes or more and 4 hours or less.

10. The method for manufacturing the cathode active material for a lithium ion secondary battery according to claim 8, the method further comprising, subsequent to the step of performing preliminary firing, a step of performing main firing of the raw material mixture after preliminary firing at 1020° C. or higher and 1120° C. or lower for 10 minutes or more and 4 hours or less.

11. The method for manufacturing the cathode active material for a lithium ion secondary battery according to claim 9, the method further comprising, subsequent to the step of performing main firing, a step of holding an obtained lithium transition metal composite oxide at 500° C. or higher and 900° C. or lower for 1 hour or more and 20 hours or less.

12. The method for manufacturing the cathode active material for a lithium ion secondary battery according to claim 10, the method further comprising, subsequent to the step of performing main firing, a step of holding an obtained lithium transition metal composite oxide at 500° C. or higher and 900° C. or lower for 1 hour or more and 20 hours or less.
